(19) United States
(12) Patent Application Publication
(10) Pub. No.: US 2024/0342759 A1
(43) Pub. Date: Oct. 17, 2024

(54) IMPULSE SCRAPER AND SCRAPER ASSEMBLY

(71) Applicant: Trelleborg Sealing Solutions Germany GmbH, Stuttgart (DE)

(72) Inventors: Mandy Wilke, Böblingen (DE); Holger Jordan, Neuhausen a.d.F. (DE)

(73) Assignee: Trelleborg Sealing Solutions Germany GmbH, Stuttgart (DE)

(21) Appl. No.: 18/754,152

(22) Filed: Jun. 26, 2024

Related U.S. Application Data
(63) Continuation of application No. PCT/EP2023/051061, filed on Jan. 18, 2023.

(30) Foreign Application Priority Data
Feb. 23, 2022 (DE) 10 2022 201 897.4

(51) Int. Cl. B08B 1/16; B08B 1/20

(52) U.S. Cl. CPC B08B 1/165; B08B 1/20

(57) ABSTRACT

An impulse scraper and scraper arrangement for scraping a foreign body off the mating running surface of a machine part is disclosed. The impulse scraper has a holding section and a scraper lip with a scraper edge, extending around the central axis of the impulse scraper, for dynamically contacting and scraping the foreign body off the mating running surface. The scraper lip is intrinsically elastically deformable and, on its peripheral side facing away from the holding section, has one or more annular material weaknesses, each defining a predetermined bending zone of the scraper lip. The scraper lip itself forms an axial stop for a respective longitudinal segment of the scraper lip arranged distally with respect to the axial stop. Alternatively, the scraper lip is arranged on the holding section via a support element, the axial deflection movement of which relative to the holding section is limited by an axial stop.

### CROSS-REFERENCE TO RELATED APPLICATIONS

This continuation application claims priority to PCT/EP2023/051061 filed on Jan. 18, 2023 which has published as WO 2023/160906 A1 and also the German application number DE 10 2022 201 897.4 filed on Feb. 23, 2022, the entire contents of which are fully incorporated herein with these references.

### DESCRIPTION

### Field of the Invention

The invention relates to an impulse scraper and a scraper arrangement.

### Background of the Invention

Scrapers are well established in many areas of engineering and are used, in particular, to scrape dirt, chips, moisture and other foreign particles off pistons or piston rods before they move back into the cylinder. This prevents contamination of the bearing gap between the components or of the hydraulic medium and damage to guides, seals and other components of the scraper arrangement. In the case of hydraulic systems of cranes and other construction machines, for example, scraper arrangements of this kind are critical components. “Double” or “tandem” scrapers with two or more scraper lips, which may have corresponding or else opposing main directions of action, are also commercially available.

The scrapers mentioned must have favorable friction properties in terms of the pairing of materials with the mating running surface to be scraped as well as the maximum possible wear resistance. The scrapers used in practice may not scrape off foreign particles adhering strongly to the piston rod, especially ice or dried-on dirt, from the piston rod, or may do so only incompletely. In this case, the abovementioned entry of contaminants into the bearing gap may occur.

### SUMMARY OF THE INVENTION

It is therefore the object of the invention to specify a scraper and a scraper arrangement with which problematic foreign particles that adhere strongly to the mating machine-part running surface to be scraped can be scraped off more reliably.

According to the invention, the object as it relates to the scraper is achieved by an impulse scraper according to the first independent claim. The scraper arrangement has the features indicated in an additional claim. Further advantages of the invention will become apparent from the description and the drawing.

The impulse scraper according to the invention is intended for scraping a foreign particle off the mating running surface of a machine part, in particular, a piston rod, and comprises a holding section for mounting the impulse scraper in/on a holding structure, in particular, a holding groove, of a machine part. The impulse scraper furthermore comprises a scraper lip with a scraper edge, extending around the central axis Z of the impulse scraper, for dynamically contacting and scraping the foreign particle off the mating running surface of another machine part.

According to a first alternative embodiment of the invention, the scraper lip is intrinsically elastically deformable and, on its peripheral side facing away from the holding section, has one or more preferably annular material weaknesses, each defining a predetermined bending zone of the scraper lip, wherein the scraper lip itself is used to form a functional axial stop for a respective longitudinal segment of the scraper lip arranged distally with respect to the axial stop.

According to a second alternative embodiment of the invention, the scraper lip is arranged on a support element, the axial deflection movement of which relative to the holding section is limited by an axial stop.

If, during the operational use of the impulse scraper—as a result of the (return stroke) movement of the piston rod—a foreign particle adhering to the piston rod is brought up against the scraper edge of the impulse scraper, this causes an axial deformation or deflection movement of the scraper lip that is suddenly limited or inhibited by the axial stop. A mechanical scraping impulse or breakaway force can thereby be exerted on the foreign particle by means of the scraper lip. By means of this scraping impulse or this breakaway force, even problematic foreign particles that adhere particularly strongly to the piston rod, e.g., ice, dried-on dirt or the like, can be removed, i.e., scraped off, even more reliably from the piston rod. During a return stroke movement of the piston rod, unwanted entry of such foreign particles into the bearing gap can be prevented even more reliably. This is advantageous overall for the ability to function and durability of a scraper arrangement provided with the impulse scraper. Thus, the impulse scraper is intended particularly for critical applications, in which it is imperative to prevent disruption of the operation of the scraper arrangement in view of the harm to people or material damage, e.g., in the case of construction machines, cranes or the like, that may possibly result therefrom.

In principle, the stop in the second alternative embodiment of the invention, by means of which an axial movement of the scraper lip counter to the main direction of action of its scraper edge, i.e., in the direction of the inner side H of the bearing or sealing gap of the scraper arrangement in the installed state, is limited, can be formed by an additional component. According to a preferred refinement of the invention, however, the support element is intrinsically deformable in a spring-elastic manner and, in respect of an axial deformation (counter to the main direction of action of the scraper edge), has an exponentially progressive spring characteristic, and therefore the abovementioned axial stop is functionally implemented or defined by the support element itself. In other words, the support element is in this case designed as a spring element with a progressive spring characteristic. This enables the impulse scraper to be implemented at low cost with a small number of components and to be used on any existing scraper arrangement. Alternatively or in addition, the functional axial stop can be formed/defined by the holding section of the impulse scraper. In this case, the holding section is intrinsically deformable in a spring-elastic manner and, in respect of its axial deformation, has an exponentially progressive spring characteristic, by means of which the axial stop is functionally implemented or defined. The holding element can have an elastomeric material or can be formed by said material, for example.

According to a refinement of the invention, it is possible, in particular, for the support element of the impulse scraper to be embodied as a reinforcing insert for the scraper lip. In this case, the scraper lip can be molded onto the reinforcing insert, something that offers advantages in terms of manufacture. In addition, it is thereby possible to achieve particularly reliable mechanical connection between the two components.

According to the invention, the support element can extend in a radial direction almost to the level or as far as the level of the scraper edge. Even in the case where a foreign particle overcomes the scraper edge in the axial direction during the operational use of the impulse scraper, this enables the support element to serve as an additional scraper or barrier for any further axial penetration of the foreign particle into the bearing gap. In this regard, the support element can also have an operative edge for scraping off foreign particles which is preferably of sharp-edged design. It is thereby possible to ensure that the foreign body is scraped off the piston rod even more reliably.

According to the invention, it is possible, in particular, for the support element to consist of metal, a plastic or a composite material.

In particular, the scraper edge can consist of a material with a Shore hardness of between 80 Shore A and 70 Shore D.

It is possible for the support element to be merely articulated in a spring-elastic manner on the holding section of the impulse scraper or else, in addition, to be intrinsically deformable in a spring-elastic manner.

According to the invention, it is possible, in particular, for the material weakness of the scraper lip to be designed as an annular notch or annular groove, wherein the groove flank of the annular groove which faces the scraper edge serves as a stop surface for the respective longitudinal segment of the scraper lip which is arranged distally with respect to the material weakness. This embodiment of the impulse scraper can be produced at particularly low cost, e.g., by injection molding.

According to a particularly preferred refinement of the invention, the scraper lip has a plurality of material weaknesses or annular grooves, which are arranged spaced apart in a direction that is axial with respect to the central axis of the impulse scraper. In this case, the annular grooves can have a depth and/or axial width which increase(s) with increasing distance between the respective annular groove and the scraper edge.

According to a particularly preferred embodiment of the invention, each material weakness of the scraper lip tapers or narrows radially in the direction of the holding section. As a result, the response of the scraper lip to an axial force acting on the scraper edge can be adjusted in a particularly simple and reliable manner.

For the sake of an even greater improvement in the scraping ability of the impulse scraper, the scraper edge can be of wavy or serrated design in the circumferential direction of the impulse scraper. It is thereby possible to minimize the contact area between the scraper edge and a foreign particle and to apply particularly large scraping forces.

The impulse scraper can furthermore have a second scraper lip, which has a main direction of action that either coincides with that of the first scraper edge or is opposed to that of the first scraper edge. In the first-mentioned case, the scraping action of the impulse scraper can be reinforced in the main direction of action of the first scraper edge and, in the other case, it is possible to achieve retention of foreign particles that have already penetrated the bearing gap or even of the lubricant arranged in the bearing gap.

If there is an annular free space extending in the radial direction between every two scraper lips of the impulse scraper, foreign particles and the like can be trapped there. A free space is understood to mean a spatial volume in which no component of the impulse scraper is arranged.

The scraper lip can furthermore have a supporting element which is arranged at an axial distance from the scraper edge and extends in a radial direction away from the scraper lip. Such a supporting element enables the impulse scraper to be supported on the mating running surface and thus an unwanted tilting moment acting on the impulse scraper to be counteracted. The supporting element is preferably formed integrally on the scraper lip. As a particular preference, the supporting element has a convex cross-sectional shape.

The scraper arrangement according to the invention comprises a first machine part in the form of a piston or a piston rod and a second machine part, preferably in the form of a cylinder, which fits around the first machine part. The two machine parts are arranged spaced apart, forming a bearing gap, and can be moved relative to one another along a movement axis. One of the two machine parts has a sliding or mating running surface and the other of the two machine parts has a holding structure, in particular, in the form of a holding groove, in which the holding section of an above-explained impulse scraper is arranged in such a manner as to be held. At least in some section or sections, the scraper lip of the impulse scraper rests (circumferentially) against the mating running surface of the first machine part.

If the scraper lip has one or more of the abovementioned material weaknesses/annular grooves, a lubricating fluid arranged in the bearing gap can be carried along into each of the weakened portions of material by a forward stroke movement of one machine part. Purely by way of friction, a return stroke movement of the machine part causes a deformation of the scraper lip and, associated with this, pressing of the lubricant out of each material weakness or annular groove of the scraper lip radially in the direction of the mating running surface. Each material weakness or annular groove thus has a dual function.

The invention is explained in greater detail below by means of exemplary embodiments illustrated in the drawing. The embodiments shown and described should not be understood as an exclusive enumeration; on the contrary they are of an illustrative character intended to describe the invention.

### BRIEF DESCRIPTION OF THE DRAWINGS

In the drawings:

FIG. 1 shows a cross section of part of a scraper arrangement comprising a piston rod and a machine part, in this case a cylinder, which fits around the piston rod, and comprising an impulse scraper, arranged between the two machine parts, for the piston rod, wherein the impulse scraper has a circumferential material weakness in the form of an annular notch (=annular groove), by means of which a predetermined bending point of the scraper lip and a stop for the longitudinal segment of the scraper lip which is arranged distally with respect to the annular notch is defined;

FIG. 2 shows a cross section of an impulse scraper which differs from the impulse scraper shown in FIG. 1 essentially in that it has on the circumference a plurality of material weaknesses spaced apart from one another in the form of annular notches that differ from one another in size;

FIG. 3 shows a cross section of part of another impulse scraper, on which the scraper lip has a support element with an exponentially progressive spring characteristic;

FIG. 4 shows a cross section of part of another impulse scraper, on which the scraper lip has two scraper edges with a mutually opposed main direction of action and a support element with an exponentially progressive spring characteristic;

FIG. 5 shows another impulse scraper, on which the scraper lip is secured on the holding section exclusively by way of a support element, wherein the holding element has an exponentially progressive spring characteristic and forms a functional stop for an axial deflection movement of the support element articulated on the holding section and of the scraper lip;

FIG. 6 shows a cross section of part of another impulse scraper, on which the scraper lip is secured on the holding section exclusively by way of a support element, wherein the holding element has an exponentially progressive spring characteristic and forms a functional stop for an axial deflection movement of the support element articulated on the holding section and of the scraper lip;

FIG. 7 shows a notched scraper edge of an impulse scraper in a perspective detail illustration;

FIG. 8 shows a scraper edge of wavy design on an impulse scraper in a perspective detail illustration; and

FIG. 9 shows an exponentially progressive spring characteristic of a holding element according to FIG. 5 and of a support element according to FIGS. 3, 4 and 6.

### DETAILED DESCRIPTION OF EMBODIMENTS OF THE INVENTION

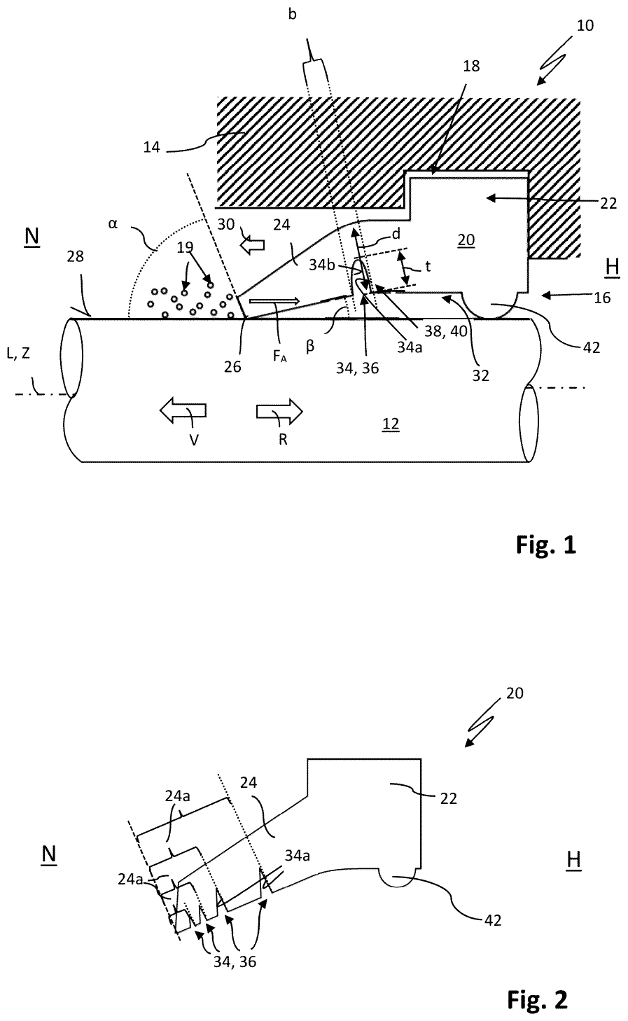

FIG. 1 shows a first exemplary embodiment of a scraper arrangement (i.e., assembly) 10 according to the invention. Here, the scraper arrangement 10 comprises a first machine part 12, in this case, by way of example, in the form of a piston rod, and a second machine part 14, in this case, by way of example, in the form of a cylinder, which surrounds the piston rod. The two machine parts 12, 14 are arranged spaced apart, forming a bearing gap 16 arranged between the two machine parts 12, 14. The scraper arrangement 10 and the bearing gap 16 have an outer side N and an inner side H. A lubricant (not shown in FIG. 1) can be arranged in the bearing gap 16. Here, the first machine part 12 can be moved backward and forward along a movement axis L relative to the second machine part 14. A forward stroke movement of the piston rod is denoted by V and a return stroke movement of the piston rod is denoted by R.

The second machine part 14 has a holding structure 18, which is embodied in this case as a holding groove. To scrape off contaminants or foreign particles 19 adhering to the piston rod, use is made of an impulse scraper 20.

The impulse scraper 20 has a mounting or holding section 22, which is arranged in the holding groove of the second machine part 14. A scraper lip 24 extends away from the holding section 22 in a direction that is axial with respect to the central axis Z of the impulse scraper 20. Here, the scraper lip 24 is provided with a single scraper edge 26 which runs around in a continuous manner in the circumferential direction of the impulse scraper 20 and serves for dynamic contacting and scraping of the mating running surface 28 of the piston rod. The scraper edge 26 has an edge angle a facing in the axial direction toward the outer side N of between 50° and 75°, and an edge angle β facing in the axial direction toward the inner side H of between 15° and 45°. The main functional direction of action of the scraper edge is denoted by the arrow 30.

According to FIG. 1, the scraper lip 24 has a single material weakness in the form of an annular groove 34 running around in the shape of a ring on its circumferential side 32 facing away from the holding section 22, i.e., in this case the radially inner circumferential side. The annular groove 34 has an axial width b and a radial depth t of at least 30% of the local thickness d of the scraper lip 24.

This material weakness of material or annular groove 34 has three functions:

If, during operation, a foreign particle 19 adhering to the mating running surface of the piston rod, such as snow, chips, ice, dirt and the like, is brought up against the scraper lip during a return stroke movement of the piston rod, an axial force F_{A} is thereby exerted on the scraper lip. The material weakness serves as a predetermined bending zone 36 of the scraper lip 24. This axial force F_{A} causes an elastic deformation (=compression) of the scraper lip 24 in the axial direction and bending (kinking) of the scraper lip 24 primarily in the region of the predetermined bending zone 36.

Secondly, the material weakness here forms an integral stop 38 for the longitudinal segment 24a of the scraper lip 24 which is distal, i.e., axial in the main direction of action. The integral stop 38 is formed by the first groove flank 34a of the annular groove 34, said flank facing the outer side N. If the second groove flank 34b of the distal longitudinal segment 24a of the scraper lip 24, the flank facing the bearing gap 16, strikes against the opposite first groove flank 34a, further axial deformation of the scraper lip 24 is thereby counteracted. Owing to the sudden rise in the resistance to further deformation, the scraper edge 26 is acted upon by a scraping impulse or breakaway force derived from the return stroke movement R of the piston rod. As the foreign particle 19 or plurality of foreign bodies 19 is detached, the sealing lip is deformed suddenly in the radial/axial direction back into its normal operating state, which is shown in FIG. 1. Overall, it is possible in this way to scrape off foreign particles 19 on the piston rod in a particularly effective manner. It is thereby possible to reliably counteract unwanted entry of foreign particles 19 into the bearing gap 16 and the associated risks of damage to other components of the scraper arrangement 10.

Thirdly, the material weakness can serve as a lubricant reservoir 40. During a forward stroke movement V of the piston rod, lubricating fluid adhering to the piston rod can be introduced or dragged into the material weakness or annular groove 34. During a return stroke movement R of the piston rod, at least some of the lubricating fluid stored in the material weakness can be returned to the piston rod. This is the case especially if—on account of friction between the scraper edge 26 and the mating running surface 28 of the piston rod—the scraper lip 24 is deformed in the axial direction and, as a result, there is a reduction in the axial width b of the material weakness, i.e., squeezing of the lubricating fluid out of the material weakness. During a subsequent forward stroke movement V, the material weakness is then filled with the lubricant again. This allows even better all-round lubrication of the piston rod and of the scraper lip. Unwanted adherence of surface rust and the like and corrosion of the piston rod itself can thereby be counteracted in a particularly reliable manner, even when the piston rod is extended out of the second machine part 14.

It should be noted that the impulse scraper 20 can have a supporting section 42, which is arranged at a distance from the scraper edge 26 in the axial direction and rests (at least temporarily) against the mating running surface 28. In operational use, the supporting section 42 can be supported on the mating running surface 28 and thus counteract a tilting moment acting on the impulse scraper 20. Here, purely by way of example, the supporting section 42 is embodied as a spherical annular bead, which does not have any sealing effect and may quite possibly have one or more axial passages in the circumferential direction. Other geometrical configurations of the supporting section are readily imaginable.

According to the exemplary embodiment illustrated in FIG. 2, the scraper lip 24 of the impulse scraper 20 may also have a plurality of material weaknesses arranged spaced apart from one another in the axial direction. In this case, each of the material weaknesses is preferably embodied as an annular groove 34 and has the above-explained functional advantages. In normal operation of the impulse scraper 20, each material weakness or annular groove 34 of the scraper lip 24 can narrow in the radial direction. The depth t of the material weaknesses can increase with increasing distance between the respective material weakness and the scraper edge 26.

It should be noted that the weakened portion of material may also be formed or filled by a highly compressible soft material with a modulus of elasticity that is low in comparison with the rest of the scraper lip 24. Consideration may be given here especially to an open-cell elastomer foam.

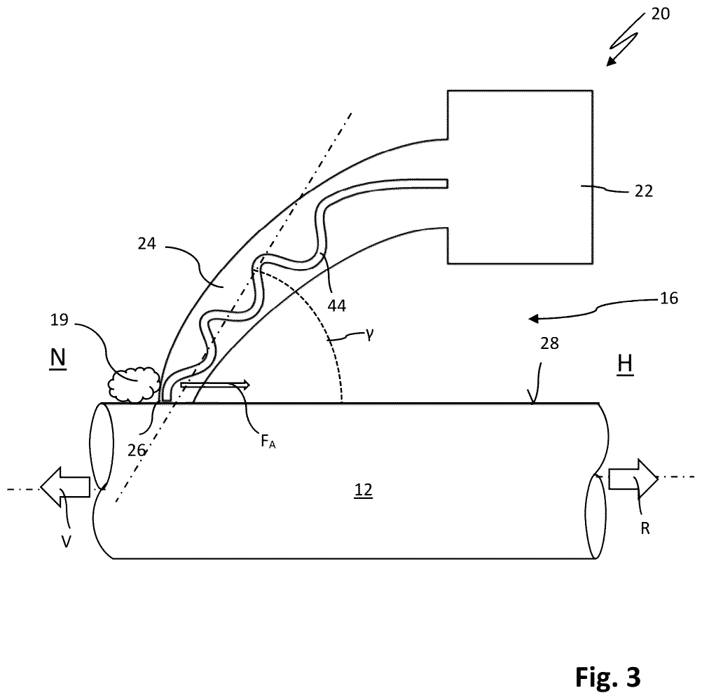

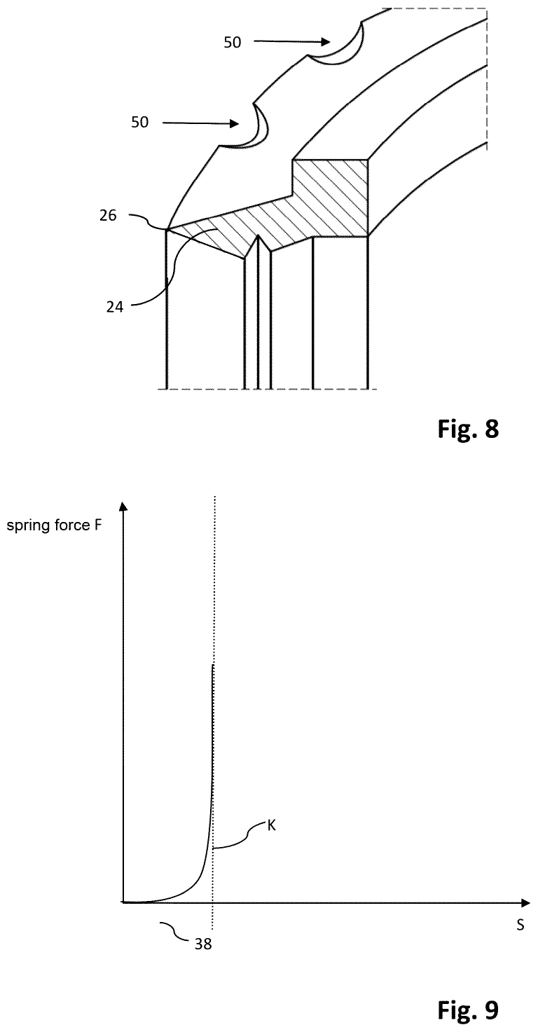

According to the exemplary embodiment shown in FIG. 3, the scraper lip 24 of the impulse scraper 20 is arranged in such a way as to be held on a support element 44. The support element 44 can be embodied in the manner of a reinforcing insert for the scraper lip 24. In particular, the scraper lip may be molded onto the support element. Here, the support element 44 extends from the holding section 22 in a radial direction almost to the level or as far as the level of the scraper edge 26. It should be noted that the material of the support element 44 may have a higher modulus of elasticity than the material of the rest of the scraper lip 24. The support element 44 may comprise metal 25, plastic and/or a composite material or may consist of one of these materials. The support element 44 is intrinsically deformable in a spring-elastic manner and has an exponentially progressive spring characteristic in respect of its axial deformation, cf. also the following explanations of FIG. 8. Consequently, the support element 44 serves as a spring-elastic energy storage device with a progressive spring characteristic. In other words, the axial force F_{A} required to deform the support element in the axial direction increases suddenly with increasing deformation of the support element. An axial stop for the axial deformation of the support element 44 and thus an axial deflection movement of the scraper lip 24 in the direction of the inner side H is thereby implemented functionally and, as a result, the scraper lip can exert a scraping impulse or a breakaway torque—derived from the return stroke movement of the piston rod—on a foreign particle adhering to the piston rod.

If the spring force of the support element 44 exceeds the axial force F_{A} at the time at which the foreign particle 19 adhering to the piston rod is scraped off (detached), the scraper lip 24 snaps back axially in the direction of the outer side N into its operational position shown in FIG. 3.

In cross section, the scraper edge 26 can have a basic shape in the form of an arc that is convex toward the outside and, in the normal operating state shown, encloses an angle y, preferably where 60°≤y≤80°, with the mating running surface 28 of the piston rod.

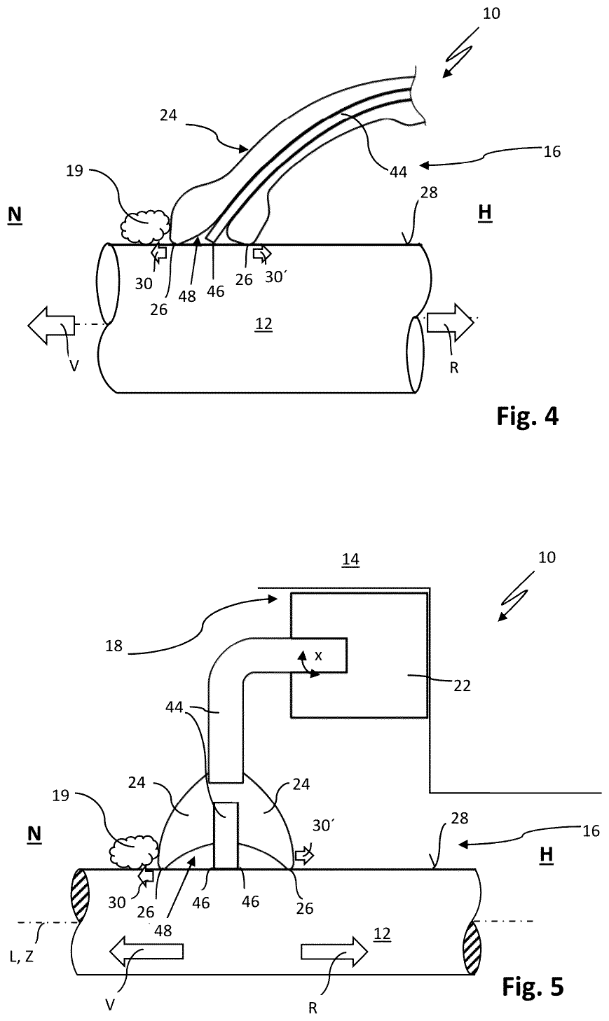

In the detail of an impulse scraper 20 in the installed state shown in FIG. 4, the support element 44 is likewise embodied as a reinforcing insert capable of spring-elastic deformation for the viscoelastic material of the scraper lip 24. In this case, the support element 44 is embodied with an arcuately curved cross-sectional shape in cross section. The scraper lip 24 has a second scraper edge 26, which is arranged offset axially in the direction of the inner side H with respect to the first scraper edge 26. Both scraper edges 26 are composed of the same material. The second scraper edge 26 has an inward main direction of action 30′ opposed to the outward main direction of action 30 of the first scraper edge 26.

It should be noted that the support element 44 itself may have an effective edge 46 with a scraping function. The effective edge 46 preferably does not touch the mating running surface 28 in normal operation so as to avoid damage to the mating running surface. Thus, the effective edge is preferably arranged at only a short distance (not designated in FIG. 4), e.g., less than 1 mm, from the mating running surface 28. It is thereby possible to even more reliably counteract the entry of relatively large, especially hard, foreign particles 19 adhering to the first machine part 12 (=piston rod), into the bearing gap 16. If the scraper lip 24 has a free space 48 formed between the first and second scraper edges 26, foreign particles 19 which have overcome the first scraper edge 26 as well as lubricant can be accommodated or stored there.

FIG. 5 shows another impulse scraper 20, on which the scraper lip 24 is retained by means of a support element 44. The support element 44 is articulated at one end on the holding section 22 of the impulse scraper 20 in a manner that allows spring-elastic deflection. The support element 44 may be flexurally rigid, i.e., substantially nondeformable, in relation to the axial forces F_{A} that occur during the operation of the impulse scraper or may have an exponentially progressive spring characteristic in accordance with the exemplary embodiment explained in connection with FIG. 4. Here, the holding section 22 at any rate is intrinsically elastically deformable and has an exponentially progressive spring characteristic in respect of a deformation. In the exemplary embodiment shown in FIG. 5, the axial stop for a (deflection) movement of the scraper lip in the axial direction is thus implemented functionally by the holding section 22. In particular, the holding section 22 can comprise an elastomer or can be composed of an elastomer.

The scraper lip 24 can have a first and a second scraper edge 26, the main directions of action 30, 30′ of which may be opposed. The impulse scraper is thus designed as a “double scraper”. The scraper lip 24 and preferably also the holding section consist of a material capable of rubber-elastic or viscoelastic deformation. In particular, the Shore hardness of the softer material can be between 80 Shore A and 70 Shore D.

The support element 44 extends to such an extent in the radial direction into a free space 48 formed between the two scraper edges 26 that the support element 44 almost touches the mating running surface 28 of the piston rod.

If, in the case of this impulse scraper 20, a foreign particle 19 adhering to the mating running surface 28 is brought up against the scraper edge 26/scraper lip 24 arranged on the outside during a return stroke movement R of the piston rod, this results in an axial force F_{A} acting on the scraper edge 26. This axial force F_{A} causes an elastic deflection of the support element together with the scraper lip 24 relative to the holding section 22. Here, as a result, the scraper edge 26 is pivoted to a greater extent toward the mating running surface 28. When the functional stop is reached, i.e., the sudden rise in the force required to deform the holding element, a scraping impulse or breakaway force is exerted on the foreign particle 19 by means of the scraper lip 24. If the spring force of the holding element 22 exceeds the axial force F_{A} at the moment when the foreign particle 19 breaks away from the mating running surface 28, the support element 44 snaps back in the axial direction into its initial position shown in FIG. 5, together with the scraper lip 24.

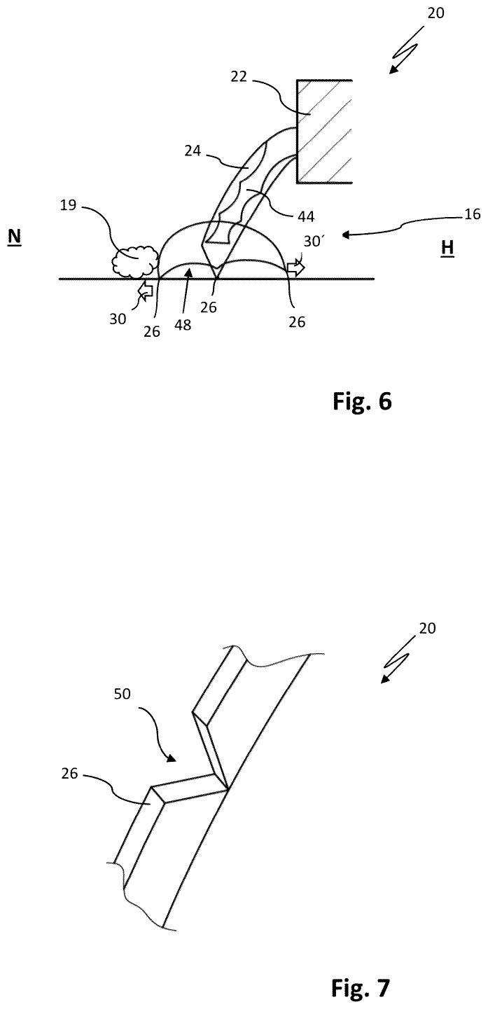

In the exemplary embodiment shown in FIG. 6, the support element 44, which is here embodied in such a way that it runs in an arc in a manner corresponding to the exemplary embodiment shown in FIG. 4 and which serves as a spring-elastically deformable reinforcing insert of the scraper lip 24, is made of metal, a viscoelastic hard plastic or a composite material. The Shore hardness of the material of the support element 44 can be between 95 Shore A and 70 Shore D, for example. Here, the scraper lip 24 has three scraper edges 26, which are arranged spaced apart from one another in the axial direction and have mutually opposed main directions of action 30, 30′. The material of the scraper lip is preferably softer in comparison with the support element or capable of viscoelastic deformation.

According to FIGS. 7 and 8, the scraper edge 26 of the scraper lip 24 can in each case be of notched or wavy design and can have depressions 50. It is thereby possible to even further improve the scraping function of the scraper lip 24, especially with respect to particularly hard foreign particles or foreign particles adhering particularly firmly to the mating running surface.

FIG. 9 shows, by way of example, an exponentially progressive characteristic K of the support element 44 of spring-elastic design shown in FIGS. 3, 4 and 6 and of the spring-elastic holding section 22 shown in FIG. 5, by means of which the above-explained functional stop 38 is implemented or formed.

What is claimed is:

1. An impulse scraper configured for scraping a foreign particle off a mating running surface of a machine part, comprising:
a holding section configured for mounting the impulse scraper in a holding structure of the machine part, and
a scraper lip, extending away from the holding section in an axial direction with respect to a central axis of the impulse scraper, with a scraper edge, extending around the central axis of the impulse scraper, configured for dynamically contacting and scraping the foreign particle off the mating running surface of another machine part;
wherein the scraper lip is intrinsically elastically deformable and, on its radial inner peripheral side facing away from the holding section, has one or more, ring-shaped circumferential, annular grooves, each defining a predetermined bending zone of the scraper lip; and
wherein the first groove flank of the annular groove which faces the scraper edge forms an axial stop for an opposite second groove flank of the annular grooves of a longitudinal segment of the scraper lip arranged distally with respect to the axial stop;
wherein an axial force which acts on the scraper lip in the axial direction relative to the holding section caused by a foreign particle adhering to the mating running surface leads to a deflection of the scraper lip primarily in the region of the predetermined bending zone until the second groove flank abuts the first groove flank.

2. The impulse scraper as claimed in claim 1, wherein the scraper edge consists of a material with a hardness of between 80 Shore A and 70 Shore D.

3. The impulse scraper as claimed in claim 1, wherein the scraper edge is of wavy or serrated design.

4. The impulse scraper as claimed in claim 1, wherein the impulse scraper has a plurality of scraper lips and/or scraper edges.

5. The impulse scraper as claimed in claim 4, wherein a first and a second scraper lip have mutually opposite main directions of action.

6. The impulse scraper as claimed in claim 1, wherein the scraper lip has a plurality of annular grooves, which are arranged spaced apart in the axial direction.

7. The impulse scraper as claimed in claim 6, wherein each annular groove of the scraper lip narrows in a radial direction.

8. The impulse scraper as claimed in claim 7, wherein the annular grooves each have a radial depth which increases with increasing distance from the scraper edge.

9. The impulse scraper as claimed in claim 1, wherein the impulse scraper has a supporting section arranged at an axial distance from the scraper edge in order to counteract a tilting moment acting on the impulse scraper while being supported on the mating running surface during the operational use of the impulse scraper.

10. A scraper arrangement comprising a first machine part and a second machine part which fits around the first machine part, which machine parts are arranged spaced apart, forming a bearing gap, wherein one of the two machine parts has the holding structure in which the impulse scraper as claimed in claim 1 is arranged to be held, and wherein the scraper lip of the impulse scraper rests against the mating running surface of the respective other machine part while making dynamic contact, wherein the foreign particle adhering to the mating running surface causes the axial force acting on the scraper lip, which leads to deformation and/or deflection of the scraper lip in the axial direction relative to the holding section until a mechanical scraping impulse acting on the foreign particle can be brought about by the axial stop in order to scrape the foreign particle off the mating running surface.

11. The scraper arrangement as claimed in claim 10, wherein the annular groove of the scraper lip serves as a lubricant reservoir and, owing to friction, a deformation or compression of the scraper lip and, associated with this, pressing of the lubricant out of the annular groove radially in the direction of the machine part that has the mating running surface is brought about during a relative movement of the two machine parts.
